(19) United States
(12) Patent Application Publication
(10) Pub. No.: US 2004/0039650 A1
(43) Pub. Date: Feb. 26, 2004

(54) Method and system for collaborative sourcing

(76) Inventor: Nathanael Lentz, (US)

Correspondence Address: MORGAN LEWIS & BOCKIUS LLP, 1111 PENNSYLVANIA AVENUE NW, WASHINGTON, DC, 20004, US

(21) Appl. No.: 10/349,184

(22) Filed: Jan. 23, 2003

Related U.S. Application Data
(60) Provisional application No. 60/350,042, filed on Jan. 23, 2002.

(51) Int. Cl. G06F 17/60

(52) U.S. Cl. 705/26

(57) ABSTRACT

The present invention relates to a system for enabling collaborative sourcing between multiple procurement entities associated with a corporation. The system includes multiple buyers that purchase multiple materials from multiple suppliers. The system also includes a processing component with an analysis component, a planning component, an execution component and a management component. The analysis component analyzes data associated with the materials and enables the corporation to optimize procurement decisions at a corporate level. The planning component forecasts and manages inventory associated the materials. The execution component communicates procurement requirements to potential suppliers and negotiates and awards contracts to selected ones of the suppliers. The management component for manages outstanding orders, contracts and logistics.

This application claims the benefit of U.S. Provisional Application No. 60/350,042, filed on Jan. 23, 2002 and incorporated by reference.

### FIELD OF THE INVENTION

The present invention relates to a system and method for integrating procurement entities within a corporation, and more particularly, relates to a system and method for facilitating collaborative sourcing between various procurement entities that are associated with the corporation.

### BACKGROUND OF THE INVENTION

Corporations typically obtain materials needed to carry out their functions from internal and external procurement entities. Sourcing within most corporations typically requires a constant negotiation process to determine which entity will bear a greater portion of the total cost. As such, strategic sourcing is usually adversarial and provides minimal sustainable benefits to the supplier and buyer of the material. During strategic sourcing negotiations, the buyer typically pushes most of the cost to the suppliers. This process generally causes the supplier to increase inventory. Moreover, traditional strategic sourcing increases the supplier's lead time and down time and decreases asset utilization and process efficiencies.

In addition to the problems associated with strategic sourcing, supplier networks associated with large corporations are typically fragmented. There is usually no way to link these fragmented networks and consolidate the purchases of components and raw materials. There also is no comprehensive manner for tracking raw material usage in large fragmented suppliers' network and managing orders and contracts.

Moreover, large corporations typically have disparate procurement information systems that do not communicate with each other. These systems usually identify products by different SKU numbers and descriptions and they often have different naming conventions that prevent corporate-wide analysis. This lack of corporate level procurement visibility and limits the corporation's negotiation leverage.

Innovative collaborative sourcing systems are therefore needed to enable corporations to conduct procurement in an efficient manner.

### SUMMARY OF THE INVENTION

The present invention relates to a system for enabling collaboration sourcing between multiple procurement entities associated with a corporation. The system includes multiple buyers that purchase multiple materials from multiple suppliers. The system also includes a processing component with an analysis component, a planning component, an execution component and a management component. The analysis component analyzes data associated with the materials and enables the corporation to optimize procurement decisions at a corporate level. The planning component forecasts and manages inventory associated the materials. The execution component communicates procurement requirements to potential suppliers and negotiates and awards contracts to selected ones of the suppliers. The management component for manages outstanding orders, contracts and logistics.

Upon receiving a procurement requirement, the processing component determines which sub-component to executed based on the procurement requirement. The processing component executes at least one selected sub component and the selected sub-component executes at least one of its pre-defined functions.

The inventive system also may include multiple existing information systems for processing procurement requirements. According to the invention, some components on each of the existing information systems may not be compatible with other components on other ones of the existing information systems. Therefore, the analysis component is executed at a higher hierarchical level than the existing information systems. The analysis component includes a knowledge architecture that enables real-time analysis across the existing information systems and allows the analysis component to normalize data across the existing information systems.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 illustrates a local area network (LAN) 100 that enables collaborative sourcing among various entities in accordance with the principles of the invention;

FIG. 2 illustrates components on computer system 104 in accordance with the principles of the invention;

FIG. 3 illustrates an example of how the inventive system is implemented within a large global retail corporation; and

FIG. 4 illustrates another example of how the inventive system is implemented within another retail corporation.

### DESCRIPTION OF PREFERRED EMBODIMENTS

Reference will now be made in detail to the preferred embodiments of the present invention, examples of which are illustrated in the accompanying drawings. The present invention described below extends the functionality of the inventive system and method for enabling collaborative sourcing among various procurement entities associated a corporation.

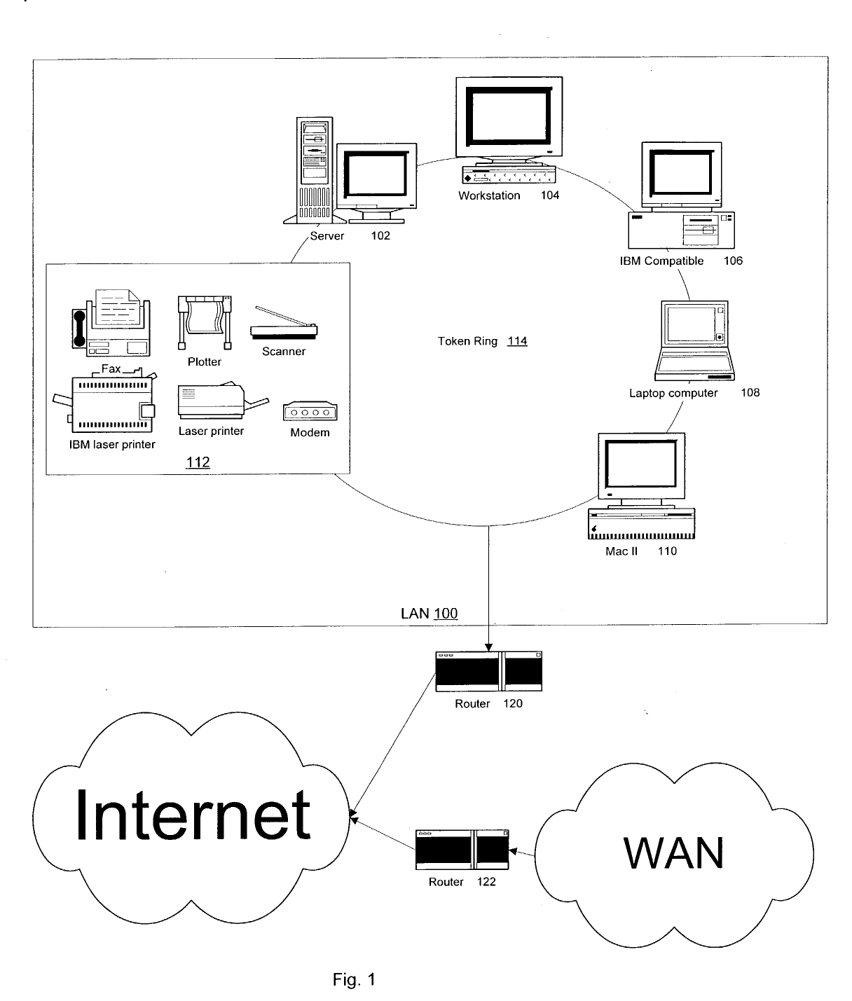

FIG. 1 illustrates a local area network (LAN) 100 that enables a corporation to implement collaborative sourcing. LAN 100 comprises a server 102, four computer system 104, 106, 108 and 110, and peripherals, such as printers and other devices 112, that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example, copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processors used to execute the inventive system and method, for example server 102 and/or computer system 104, 106, 108 and 10, include electronic storage media, such as disks, for storing programming code and data structures used to implement the inventive method and outputs therefrom. The invention uses computer system 104 to implement the invention described herein. Note, however, that any computer system may be configured to implement the inventive method and computer system 104 is only used for exemplary purposes.

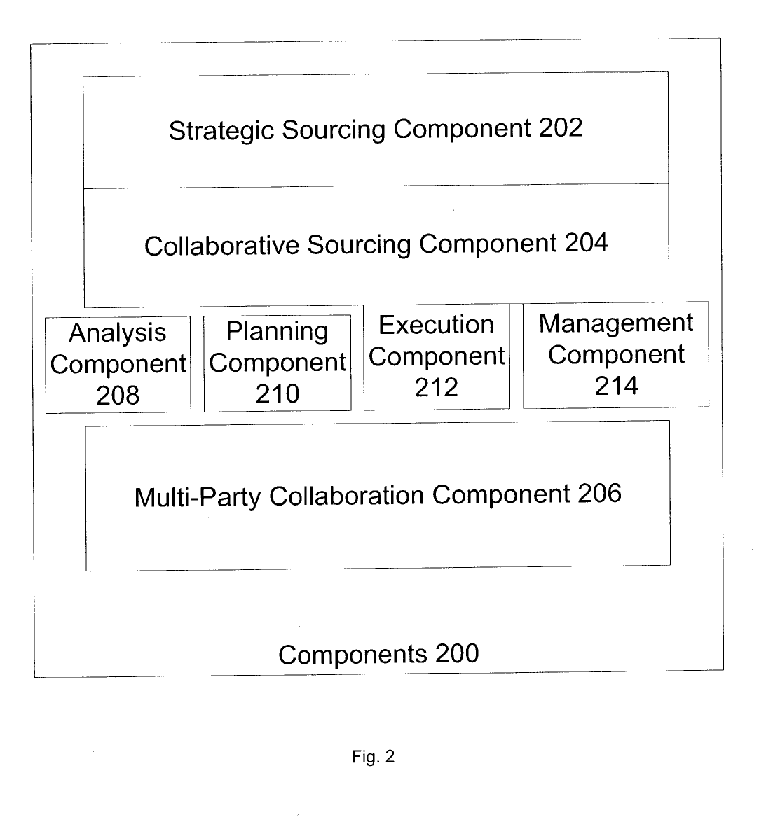

FIG. 2 illustrates components 200 on computer system 104 that enable procurement entities associated with the corporation to engage in collaborative sourcing. As shown, and discussed in more detail below, components 200 include a strategic sourcing component 202, a collaborative sourcing component 204, and a multi-party collaboration component 206. Strategic sourcing component 202 reduces material costs for the corporation, enables more efficient negotiations between entities associated with the corporation, provides an integrated supplier and order management system, and enables better procurement planning. Collaborative sourcing component 204 combines sourcing efficiency with supply chain efficiency and provides sustained profit improvement throughout the supply chain. Collaborative sourcing component does not simply transfer cost from the corporation to the supplier; it enhances cost elimination, flexibility and customer response. Multi-party collaboration component 206 provides a seamless link between business partners, better visibility and response between participants in the corporation and a strategic advantage across the supply chain.

Computer system 104 further includes an analysis component 208, a planning component 210, an execution component 212 and a management component 214. Analysis component 208 analyzes data associated with materials purchased by the corporation. Planning component 210 forecasts and manages the corporation's inventory. Execution component 212 negotiates with and awards contracts to suppliers. Management component 214 manages outstanding orders, contracts and logistics. As is apparent to one skilled in the art, other components may be added to the inventive system without changing the scope and benefits of the invention.

In a preferred embodiment, analysis component 208 also extracts data from multiple sources, normalizes historical data, aggregates spend data from disparate enterprise systems, analyzes spend data and monitors compliance, creates vendors scorecards to monitor compliance, rationalizes SKUs associated with products and identifies substitute products to consolidate purchasing power, and aggregates demand for a given material. When a corporation includes multiple divisions with different information systems, analysis component 208 enables the corporation to optimize procurement decisions at the corporate level. According to the invention, to execute the functions described above, analysis component 208 is implemented on top of existing information systems in the corporation. Analysis component 208 includes a knowledge architecture that allows real-time analysis across the existing information systems and that allows normalization of data across all existing systems. This enables the existing information systems to maintain their local numbering schemes.

According to the invention, planning component 210 specifies products used within the corporation and the categories to which each product belongs. Planning component 210 also creates a profile for each supplier and customer associated with the corporation, creates and models supply and demand plans, collaborates on forecasts, schedules and inventory, and manages supply chain events. As such, planning component 210 improves manufacturing productivity for the corporation and its suppliers by reducing inventory due to real time supply and demand. Planning component 210 also ensures supply availability and thereby decreases lost sales and provides a smoother manufacturing process. Moreover, planning component 210 overcomes geographic and product identifier issues, identifies and qualifies new suppliers to increase cost reductions for the corporation, and uses automated processes to expand strategic sourcing to more material purchases.

Execution component 212 communicates requirements to potential suppliers and negotiates the best strategic terms to minimize total cost. Specifically, execution component 212 defines requests, such as requests for quotation (RFQ), identifies qualified suppliers, conducts private on-line negotiations with suppliers, analyzes and compares bids presented by suppliers, conducts auctions where necessary, and awards contracts/orders to suppliers. Execution component 210 significantly reduces sourcing time and improves process efficiency by focusing only on qualified suppliers. Execution component 210 also reduces the cost of material by providing multiple bidding processes, and minimizes negotiated costs by analyzing total bid elements.

Management component 214 manages catalogs, contracts, and orders, tracks logistics and creates financial settlements. According to the inventive system, management component 214 realizes negotiated savings through contract compliance. Management component 214 preferably reduces processing costs by managing both incoming and outgoing orders. Management component 214 also tracks products from sale through delivery to ensure the product availability. Additionally, management component 210 decreases costs by automating financial payments, and streamlines purchasing processes by enabling suppliers and purchasing staff within the corporation to focus on core activities.

According to the invention, components 208-214 may implement one or more of the functions described above in response to the problem being addressed within a given corporation. The objective of components 208-214 is to enable true multi-enterprise visibility and collaboration for both data and business processes. In a preferred embodiment, a corporation may begin collaborative sourcing with procurement entities by executing one of the analysis component 208, planning component 210, execution component 212 and management component 214. Thereafter, the corporation may expand to one or more other components.

The inventive system enables the corporation to easily connect internal and external procurement partners, extract and normalize data from both internal and external systems, control access to both internal and external trading partners, and work with multiple suppliers and buyers simultaneously. The invention also provides a system that is easily and quickly integrated with existing systems. The invention further provides a single and comprehensive view of all purchasing data associated with the corporation. As is apparent to one skilled in the art, analysis component 208, planning component 210, execution component 212 and management component 214 may include other functions without deviating the scope of the inventive system.

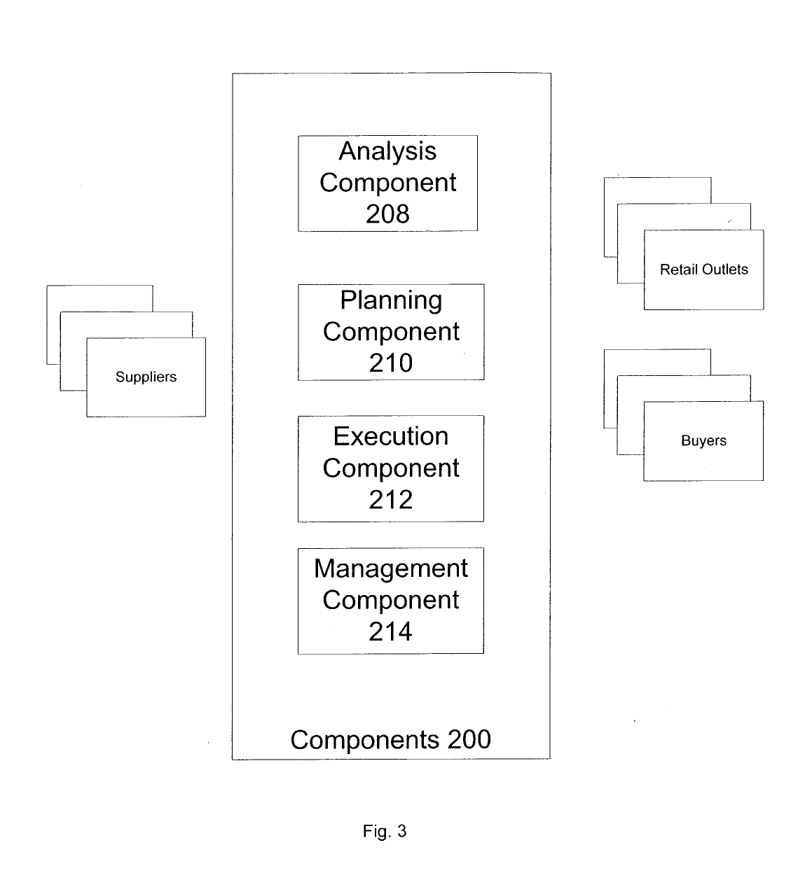

FIG. 3 illustrates an example of how the inventive system is implemented within a large global retail corporation with a wide variety of products, multiple business units, and a large number of suppliers and retail outlets. According to FIG. 3, analysis component 208 aggregates demand within the corporation. Planning component 210 creates a profile of suppliers and customers associated with the corporation, collaborates on forecasts, schedules and inventory, and creates and models supply and procurement plans. Execution component 212 defines among other requests, RFIs, RFPs, and RFQs, conducts on-line negotiations, analyzes and compares bids from various suppliers and awards contracts. Management component 214 manages catalogs, contracts and orders and tracks logistics. The inventive collaborative sourcing solution, therefore, allows the corporation to turn complex supply relationships into a competitive business advantage.

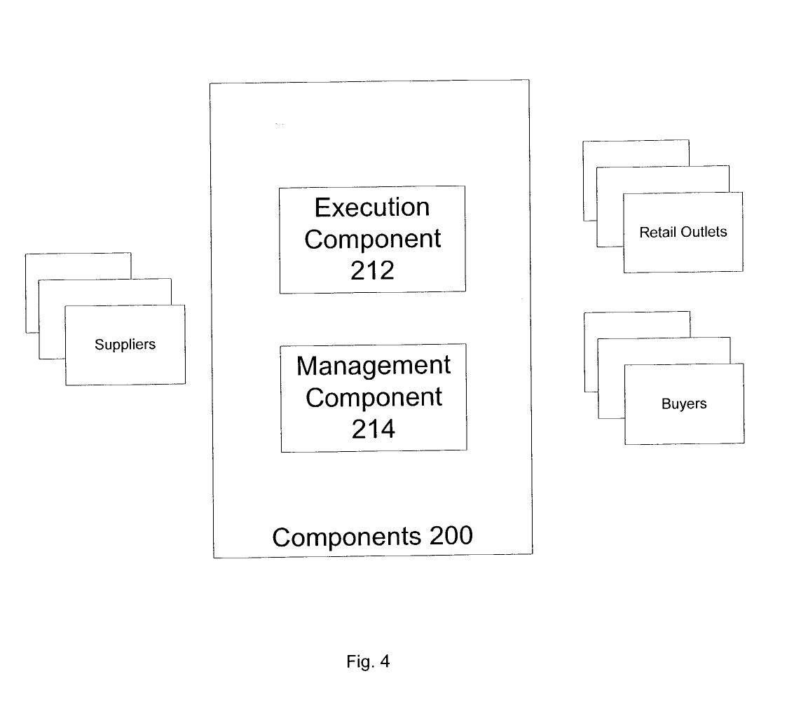

FIG. 4 illustrates another example of how the inventive system is implemented within a large global retail corporation that wants to streamline purchasing processes for its store and reduce the costs of indirect materials by automating requisitions and ordering processes, analyzing historical spending, and eliminating maverick buying. According to FIG. 4, execution component 212 defines among other requests, RFIs, RFPs, and RFQs, conducts on-line negotiations, conducts auctions and awards contracts. Management component 214 manages catalogs, contracts and orders and creates financial settlements. Note that in FIG. 4 only execution component 212 and management component 214 are implemented. FIGS. 3 and 4 are presented to illustrate that one or more of components 208-214 may be implemented in response to the requirements of the corporation. Moreover, components 208-214 may implement one or more of their associated functions in response to the needs of the corporation.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for enabling collaborative sourcing between multiple procurement entities associated with a corporation, the system comprises:
a plurality of buyers for purchasing a plurality of materials from a plurality of suppliers;
a processing component with a plurality of sub-components, wherein the plurality of sub-components comprise:
an analysis component that analyzes data associated with the plurality of materials and enables the corporation to optimize procurement decisions at a corporate level,
a planning component that forecasts and manages inventory associated the plurality of materials,
an execution component for communicating procurement requirements to potential suppliers and negotiating and awarding contracts to selected ones of the plurality of suppliers, and
a management component for managing outstanding orders, contracts and logistics; and
wherein upon receiving a procurement requirement, the processing component selects sub-components to implement based on the procurement requirement, the processing component implements at least one of the selected sub components and each implemented sub-component executes at least one pre-defined function.

2. The system of claim 1, wherein the analysis component extracts data from multiple sources, normalizes historical data, rationalizes identifiers associated with the plurality of material and identifies substitute products, and aggregates demand for a given material.

3. The system of claim 1, wherein the analysis component aggregates spend data from disparate enterprise systems, analyzes the spend data, and creates a vendor scorecard to monitor compliance.

4. The system of claim 1, wherein the analysis component is implemented on top of existing information systems in the corporation and wherein the analysis component includes a knowledge architecture that enables real-time analysis across the existing information systems and allows the analysis component to normalize data across the existing information systems.

5. The system of claim 1, wherein the planning component specifies products and categories of products used within the corporation and overcomes geographic and product identifier issues associated with multiple suppliers.

6. The system of claim 1, wherein the planning component creates a profile for each supplier and customer associated with the corporation.

7. The system of claim 1, wherein the planning component creates and models supply and demand plans, collaborates on forecasts, schedules and inventory, manages supply chain events and reduces inventory due to real time supply and demand.

8. The system of claim 1, wherein the execution component defines requests, identifies qualified suppliers, conducts private on-line negotiations with the qualified suppliers, compares bids presented by the qualified suppliers, conducts auctions and awards contracts to selected suppliers.

9. The system of claim 1, wherein the management component manages catalog, contract and orders associated with procurement, tracks logistics associated with procurement, and creates financial settlements.

10. The system of claim 1, wherein the processing component initiates collaborative sourcing within the corporation by executing any one of the plurality of sub-components.

11. A method for enabling collaborative sourcing between multiple procurement entities associated with a corporation, the method comprises the steps of:
receiving a procurement requirement
selecting, by a processing component, sub-components based on the procurement requirement;
implementing at least one of a plurality of sub-components, wherein each of the plurality of sub-components implements at least one of the functions associated with analyzing data associated with a plurality of materials and enabling the corporation to optimize procurement decisions at a corporate level, forecasting and managing inventory associated the plurality of materials, communicating procurement requirements to potential suppliers and negotiating and awards contracts to selected ones of the plurality of suppliers, and managing outstanding orders, contracts and logistics.

12. A system for enabling collaborative sourcing between multiple procurement entities associated with a corporation, the system comprises:
a plurality of buyers for purchasing a plurality of materials from a plurality of suppliers;
a plurality of existing information systems for processing procurement requirements, wherein some components on each of the plurality of existing information systems is not compatible with other components on other ones of the plurality of existing information systems; and
a processing component with a plurality of sub-components, wherein the plurality of sub-components comprise an analysis component that analyzes data associated with the plurality of materials and enables the corporation to optimize procurement decisions at a corporate level and the analysis component is executed at a higher hierarchical level than the plurality of existing information systems,
wherein the analysis component includes a knowledge architecture that enables real-time analysis across the existing information systems and allows the analysis component to normalize data across the existing information systems, and
wherein upon receiving a procurement requirement, the processing component determines which sub-component to implement based on the procurement requirement and implements at least one of the sub components and each implemented sub-component executes at least one pre-defined function.
